(19) United States
(12) Patent Application Publication
(10) Pub. No.: US 2023/0042732 A1
(43) Pub. Date: Feb. 9, 2023

(54) FREEZE SYSTEM FOR VISCOUS FLUIDS

(71) Applicant: DIPPIN' DOTS CRYOGENICS, L.L.C., Oklahoma City, OK (US)

(72) Inventor: Stan Jones, Vienna, IL (US)

(21) Appl. No.: 17/881,924

(22) Filed: Aug. 5, 2022

Related U.S. Application Data
(60) Provisional application No. 63/231,003, filed on Aug. 9, 2021.

(51) Int. Cl. A23L 3/36; F25D 13/06; A23L 3/00; A23D 9/05

(52) U.S. Cl. CPC A23L 3/362; F25D 13/067; A23L 3/001; A23D 9/05; F25D 2400/30; A23V 2002/00

(57) ABSTRACT

A process and system in which solid droplets of a lipid product are prepared. The liquid lipid product is introduced into a freeze tunnel by one or more nozzles so as to form droplets of the liquid product. The droplets are introduced onto a conveyor belt at a first end of the freeze tunnel. The freeze tunnel is at a temperature sufficient that the droplets assume a semisolid state on or before contacting the conveyor belt and then become solid droplets as they pass through to a second end of the freeze tunnel.

### CROSS-REFERENCE TO RELATED APPLICATION

This application claims the benefit of U.S. Provisional Application No. 63/231,003 filed Aug. 9, 2021, which is hereby incorporate by reference.

### FIELD

The present disclosure relates generally to the field of frozen foods, and more specifically, to the preparation of frozen viscous products for use in the preparation and processing of processed foods.

### BACKGROUND

Oils and fatty acids have many uses in prepared and/or processed foods. For example, meat-like food products (food product that is not derived from an animal but has structure, texture, and/or other properties comparable to those of animal meat) depend on adding oils, fatty acids or other lipids to plant protein to provide the structure, texture and/or other properties comparable to those of animal meat.

However, such lipids are subject to spoilage during transportation and storage if kept at room temperature or above. Additionally, such lipids are often liquids at room temperature or above. While transport and storage of large volumes of liquids is common, such large volumes are more difficult to use and proportion out in food preparation than particulate solids. Further, if the lipids are maintained below room temperature to delay spoilage, they often congeal into a solid mass which, in large volumes, is even more difficult to use and proportion out in food preparation than liquids.

Accordingly, improvements in the transportation, storage and use of lipids for food preparation would be advantageous.

### BRIEF DESCRIPTION OF THE DRAWINGS

The foregoing summary as well as the following detailed description of the preferred embodiments of the present invention will be better understood when reviewed in conjunction with the appended drawing(s). It should be understood that the invention is not limited to the precise arrangements and instrumentalities shown. Further, the components in the drawing(s) are not necessarily to scale, emphasis instead is placed upon clearly illustrating the principles of the present invention. Moreover, in the drawings, like reference numerals designate corresponding parts throughout the several views. In the drawings:

FIG. 1 is a schematic illustration of one embodiment of a freeze tunnel device in accordance with the current disclosure.

FIG. 2 is a schematic illustration of one embodiment of product nozzles that can be used with the freeze tunnel of the current disclosure.

FIG. 3 is a schematic diagram of a product nozzle.

FIG. 4 is a schematic diagram showing some of the features of a dye roller in accordance with the current disclosure.

### DETAILED DESCRIPTION

The present disclosure may be understood more readily by reference to the following detailed description and figures. In addition, numerous specific details are set forth in order to provide a thorough understanding of the embodiments described herein. However, those of ordinary skill in the art will understand that the embodiments described herein can be practiced without these specific details. In other instances, methods, procedures and components have not been described in detail so as not to obscure the related relevant feature being described.

This disclosure concerns frozen viscous products and processes for preparing the same. The frozen viscous products of this disclosure are products which are frozen to a solid or semisolid form. One area of particular application is for freezing lipids to a solid or semisolid form, and this disclosure will generally refer to the freezing of lipids hereunder; however, it should be understood that the techniques can have broader application and, except where indicated, should not be limited to producing frozen lipid products.

As used herein, the following terms will have the following meanings.

“Frozen” or “freezing” or the like refers to reducing the temperature of a substance. For applications hereunder, the temperature reduction will typically be a reduction of at least 10° C., at least 20° C., or at least 30° C. For example, if the substance starts out at about room temperature (about 27° C.), it would be frozen by reducing its temperature to a temperature below 0° C., and more typically to about −5° C. or less, about −10° C. or less, or even −20° C. or less. Generally, the substances discussed herein are not homogenous. For example, a vegetable oil (such as olive oil) is made up of several different lipids, usually with a mixture of molecules of different sizes and shapes. Accordingly, the substances will not have a sharply defined freezing temperature that represents a transition from liquid to a solid; rather, they will have a freezing temperature range, or a transition range of temperatures. Accordingly, as used herein “frozen” or “freezing” does not refer to such a transition from liquid to a solid at a sharply defined freezing temperature.

“Frozen products”, “frozen substance”, “frozen lipids” or the like refers to a product/substance/lipid that has been frozen to a solid or semisolid form.

“Frozen lipid products” means a lipid product that has been frozen to a solid or semisolid form.

“Lipid” generally includes fatty acids, waxes, steroids, fat-soluble vitamins (such as vitamins A, D, E and K), monoglycerides, diglycerides, triglycerides and phospholipids. In this disclosure, “lipid” specifically refers to edible lipids that can be used in food products. Examples of suitable lipids include but are not limited to microbial oil, plant oil, algal oil, fungal oil, marine oil, (e.g., Atlantic fish oil, Pacific fish oil, Mediterranean fish oil, light pressed fish oil, alkaline treated fish oil, heat treated fish oil, light and heavy brown fish oil, bonito oil, pilchard oil, tuna oil, sea bass oil, halibut oil, spearfish oil, barracuda oil, cod oil, menhaden oil, sardine oil, anchovy oil, capelin oil, Atlantic cod oil, Atlantic herring oil, Atlantic mackerel oil, Atlantic menhaden oil, salmonid oil, shark oil, squid oil, cuttlefish oil, octopus oil, hill oil, seal oil, whale oil), docosahexaenoic acid, eicosapentaenoic acid, conjugated fatty acids, eicosanoids, palmitic acid, glycolipids (e.g., cerebrosides, galactolipids, glycosphingolipids, lipopolysaccharides, gangliosides), membrane lipids (e.g., ceramides, sphingomyelin, bactoprenol), glycerides, second messenger signaling lipid (e.g., diglyceride), triglycerides, prenol lipids, prostaglandins, saccharolipids, oils (e.g., non-essential oils, essential oils, almond oil, aloe vera oil, apricot kernel oil, avocado oil, baobab oil, calendula oil, canola oil, corn oil, cottonseed oil, evening primrose oil, grape oil, grape seed oil, hazelnut oil, jojoba oil, linseed oil, macadamia oil, natural oils, neem oil, non-hydrogenated oils, olive oil, palm oil, coconut oil, partially hydrogenated oils, peanut oil, rapeseed oil, sesame oil, soybean oil, sunflower oil, synthetic oils, vegetable oil), omega-fatty acids (e.g., arachidonic acid, omega-3-fatty acids, omega-6-fatty acids, omega-7-fatty acids, omega fatty acids), and phospholipids (e.g., cardiolipin, ceramide phosphocholines, ceramide phosphoethanolamines, glycerophospholipids, phasphatidic acid, phosphatidylcholine, phosphatidylethanolamine, phosphatidylinositol, phosphosphingolipids, phosphatidylserine), fatty acids having a range of carbon atoms (e.g., from about 8 to about 40, from about 10 to about 38, from about 12 to about 36, from about 14 to about 34, from about 16 to about 32, from about 18 to about 30, or from about 20 to about 28 carbon atoms), fatty acids that comprise at least one unsaturated bond (i.e., a carbon-carbon double or triple bond (e.g., at least 2, at least 3, at least 4, at least 5, at least 6, at least 7, or at least 8 carbon-carbon double bonds and/or triple bonds)), fatty acids with conjugated unsaturated bonds (i.e., at least one pair of carbon-carbon double and/or triple bonds are bonded together, without a methylene (CH2) group between them (e.g., 4CH:CHi CH:CHi)), derivatives of the above named fatty acids (e.g., esters [e.g., methyl and ethyl esters], salts [e.g., sodium and potassium salts], triglyceride derivatives, diglycerides derivatives, monoglyceride derivatives, crude oils, semi-refined (also called alkaline refined) oils, refined oils, oils comprising re-esterified triglycerides, fatty acids with low interfacial tension (e.g., less than about 20, less than about 15, less than about 11, less than about 9, less than about 7, less than about 5, less than about 3, less than about 2, less than about 1, or less than about 0.5 dynes/cm, from about 0.1 to about 20, from about 1 to about 15, from about 2 to about 9, from about 3 to about 9, from about 4 to about 9, from about 5 to about 9, from about 2 to about 7, from about 0.1 to 5, from about 0.3 to 2, or from about 0.5 to 1 dynes/cm, about 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, or 20.0)), fatty acids suitable for human consumption (e.g., oils that are liquid at ambient temperature like avocado, mustard, coconut, cottonseed, fish, flax seed, grape, olive, palm, peanut, rapeseed, safflower, sesame, soybean, sunflower; oils that are solid at ambient temperature like butter fat, chocolate fat, chicken fat), conventional fat substitutes (e.g., fatty acid-esterified alkoxylated glycerin compositions, sucrose fatty acid esters, sole fats (e.g., palm oil, palm kernel oil, coconut oil, cocoa butter, shea butter, butter fat, milk fat), soft fats (e.g., canola oil, soybean oil, sunflower oil, safflower oil, olive oil, nut oils), vegetable fats and oils (e.g., soy bean, corn, cotton seed, rapeseed, rice, peanut, and palm)), and derivatives thereof. The lipid may be derived from any one natural or modified natural source or from multiple natural or modified natural sources. In some embodiments, the lipid is not derived from a natural or modified natural source but is identical or similar to lipid found in a natural or modified natural source. For example, the lipid is synthetically or biosynthetically generated but is identical or similar to lipid found in a natural source. In some embodiments, at least some of the lipid is derived from plant.

“Lipid product” refers to a substance that comprises lipids. Such substances comprise at least 80% by weight lipids; and more typically, at least 90% by weight lipids, or at least 95%, 97%, 98% or 99%, 99.5% or 99.9% by weight lipids. In some embodiments, the substance will consist essentially of lipids, meaning that the substance consists entirely of lipids except for some trace amounts of non-lipid material; thus, typically will be more than 99.95% lipid by weight. In other embodiments, the substance consists entirely of lipids.

“Semisolid” means a physical state lying between a solid and liquid, and wherein the semisolid substance has the ability, like a solid, to support its own weight and hold its shape at atmospheric pressure; but like a liquid, can conform in shape to something applying pressure (above atmospheric, and typically, by at least 1 psig, at least 2 psig, or at least 5 psig) to it and the ability to flow under such pressure.

“Solid product”, “solid lipid” and the like refer to something in the solid state.

“Solidified” as used herein refers to a physical state of being either a solid or a semisolid.

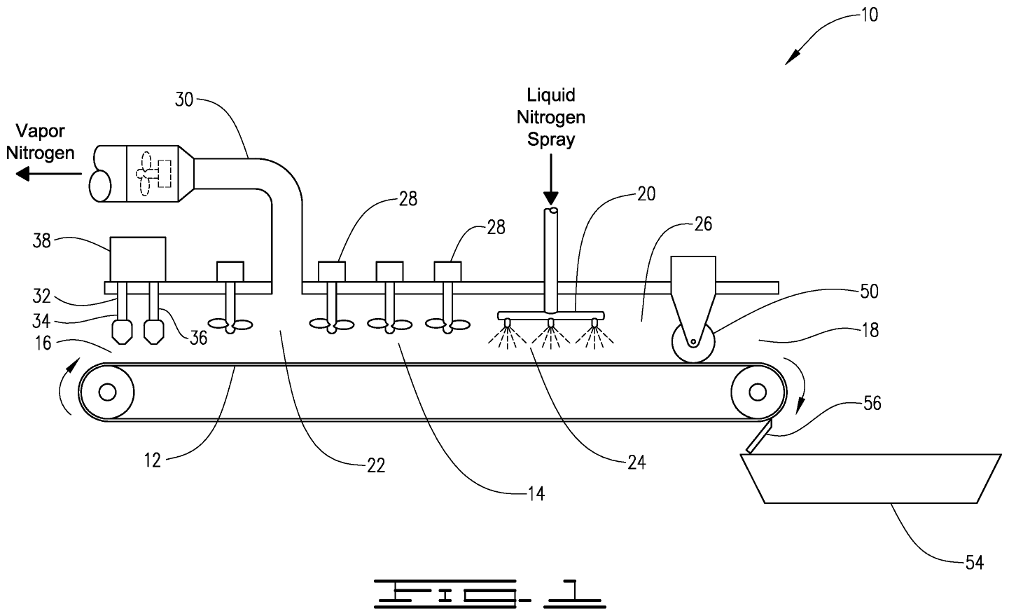

In some embodiments, a lipid product is frozen to a solid or semisolid state in a type of freezer generally referred to as a tunnel freezer. A suitable tunnel freezer 10 in accordance with this disclosure is schematically illustrated in FIG. 1. Freezer 10 comprises a belt 12 for moving substances through a chamber 14. While FIG. 1 simplistically illustrates chamber 14 being open on the sides and bottom, those skilled in the art will realize that chamber 14 is typically enclosed, except at entrance end 16 and exit end 18.

A refrigerant is introduced into chamber 14 through nozzles 20. The refrigerant is typically a liquified gas, such as liquid nitrogen or liquid carbon dioxide, which can act as a refrigerant without affecting the food quality of the lipid. Nozzles 20 are positioned within chamber 14 so as to establish a pre-cooling area 22, a freezing area 24 and a sub-cooling area 26. Freezing area 24 is located directly around nozzles 20 and is the coldest of the three areas. Pre-cooling area 22 and sub-cooling area 26 are typically warmer than freezing area 24 but are maintained at a temperature below the ambient temperature outside chamber 14 by refrigerant gasses flowing from freezing area 24. Cooling of the three areas is aided by fans 28, which disperse the refrigerant throughout chamber 14 for optimal efficiency. Additionally, vent duct 30 can vent excess nitrogen gas from chamber 14.

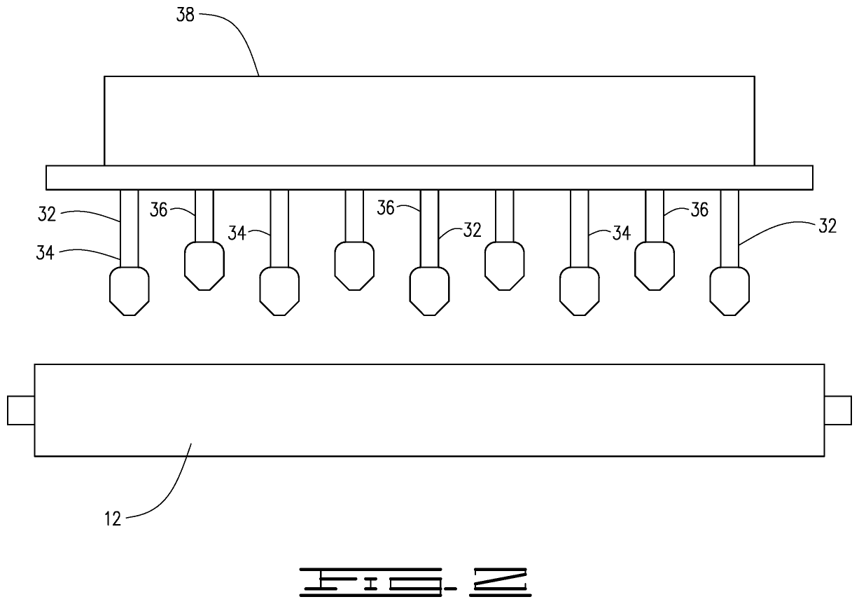

Lipid product is introduced onto belt 12 through product nozzles 32. As illustrated in FIGS. 1 and 2, there can be multiple rows 34,36 of nozzles 32 and multiple nozzles 32 in each row; however, the exact number and arrangement will depend on the desired placement of lipid onto belt 12. For example, in FIGS. 1 and 2, there is illustrated a first row 34 having five nozzles, and second row 36 having four nozzles; however, in some embodiments there may be only one row and in other embodiments there may be three or more rows. Likewise, the number of nozzles in each row may vary.

Nozzles 32 can be fed lipid product from a chamber or tray 38. The lipid product in chamber 38 will be in a liquid state; however, where needed, the lipid product in chamber 38 can be cooled or heated relative to ambient temperature to achieve a desirable viscosity for the liquid to pass through nozzles 32 to form droplets.

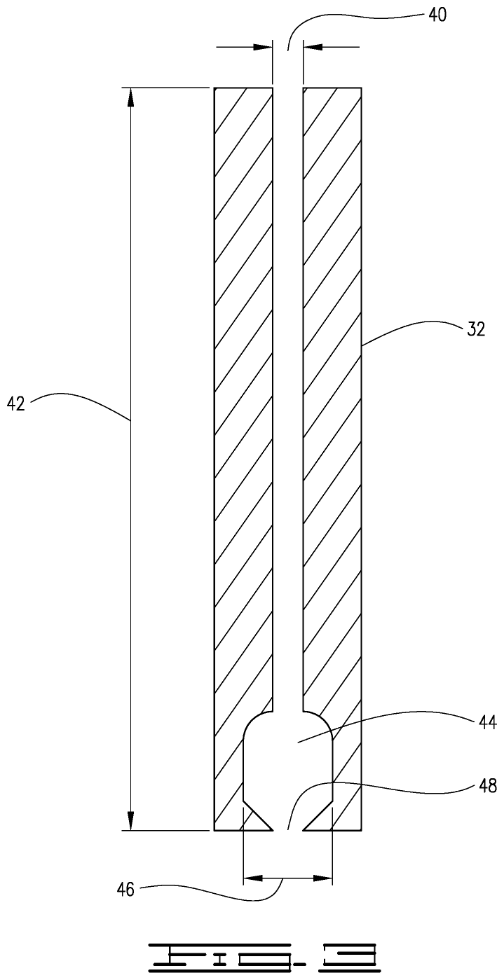

A nozzle design is illustrated in FIG. 3. It will be noticed that the design of FIG. 3 differs from that illustrated in FIG. 2. While FIG. 2 shows separate tubes ending in nozzle heads extending from chamber 38, FIG. 3 illustrates an embodiment where a tubular passage and an accumulation chamber 44 (nozzle head) are defined by a solid, typically metal, box. The box could define one tubular shape and accumulation chamber or define several. Whether the nozzles are in accordance with FIG. 2 or FIG. 3 or another configuration, the nozzle design is configured to create uniform droplets by lipid product entering a pre-determined feed inlet diameter 40 and length 42, flowing down into an accumulation chamber 44 so as to achieve the diameter of the spherical droplet desired. Different diameters of inlet feed 40 and diameters 46 of accumulation chambers 44 can be used to accommodate various viscosities. The exit 48 of the accumulation chamber can be either concave (shown) or convex depending on viscosity of the lipid product and the droplet separation characteristics. The exit size is also chosen to achieve the desired droplet diameter.

Nozzle 32 design and position are configured to place uniform droplets spaced out on conveyor belt 12 so as to be chilled within the freeze tunnel, typically to a temperature from about −40° F. to about +40° F. (about −40° C. to about +4.4° C.). The height of the nozzle's exit 48 from the surface of conveyor belt 12 will typically be determined by the viscosity and density of the lipid product, and lipid product density, but will typically be from ¼ inch to 20 inches. The nozzles can be fixed to an adjustable height mechanism so as to readily change the height to compensate for different viscosity and density of various lipid products.

Belt 12 is designed to retain the lipid product droplets; and thus, is not a conventional steel mesh, which would allow the lipid to seep through belt 12 before freezing. In some embodiments, belt 12 is a solid flexible belt, which can be made up over overlapping plates to effectively form a solid flexible belt.

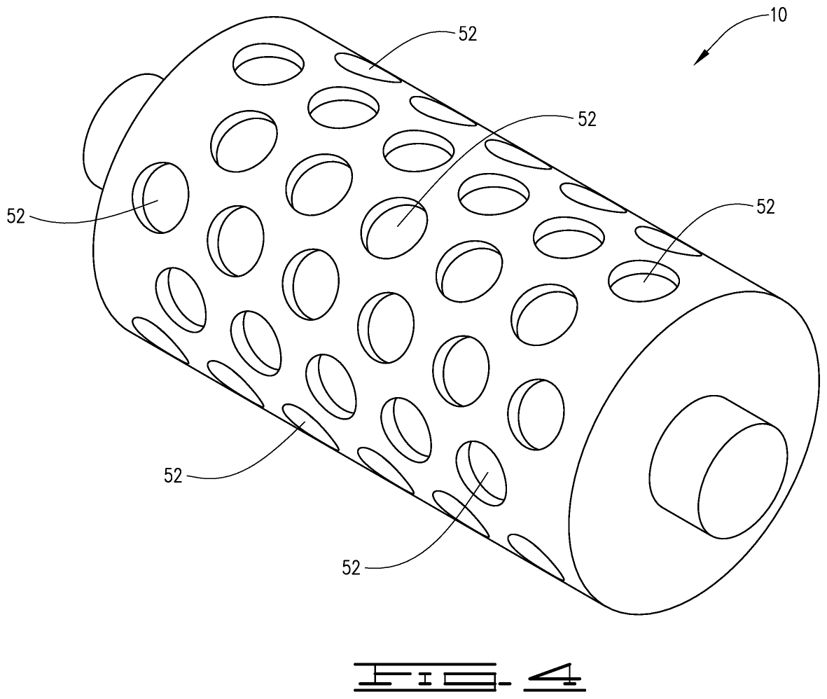

The passing of the droplets through freeze tunnel 10 will result in relatively small individual droplets being frozen to a solid or semisolid state. The droplets will typically have a spherical shape with a flat side (the bottom contacting belt 12). However, in some embodiments, additional shaping may be accomplished by the droplet continuing on the conveyor and passing under a compression dye roller 50 to produce a desired shape. Generally, roller 50 will be positioned within sub-cooling area 26. Roller 50 can be a spring tension compression roller with desired dyes 52 (shown in FIG. 4) carved into the compression roller. Roller 50 forms the solidified droplets into a pre-designed shape, if the spherical shape with a flat side was not the desired effect. As illustrated, the dyes 52 are of an oval shape; however, other shapes can be readily used.

Solidified droplets (which refers to either the un-molded droplets or molded droplets) exit freeze tunnel 10 through exit end 18, and generally will fall off belt 12 into a bin 54, a secondary conveyor belt, or similar. A blade 56 can be positioned so as to contact any droplets that do not self-release from belt 12. Blade 56 will thus detach or scrape any such droplets from belt 12, and thus they also fall into bin 54 or onto a conveyor belt, or similar.

Accordingly, a typical process for forming solidified droplets comprises introducing lipid product from chamber 38 (or another delivery device) into nozzles 32 so as to produce droplets which land on belt 12 in pre-cooling area 22. Pre-cooling area is typically warmer than freezing area 24, but sufficiently cool so that lipid droplets have sufficient viscosity so as not to lose their shape while traveling to freezing area 24.

Conveyer belt 12 continuously moves so as to constantly be placing an unused section under nozzles 32 to receive droplets and transport droplets from pre-cooling areas 22 to freezing area 24, then to sub-cooling area 26, and then to exit end 18. In freezing area 24, the droplets are exposed to the refrigerant spray so as to bring them to the desired freezing temperature. While this can be a temperature that produces either a solid droplet or a semisolid droplet, typically, a solid droplet will be produced. In sub-cooling area 26, the droplets are molded (if desired) by dye roller 50, then are introduced into bin 54 or another storage device, or are transported by a further conveyer belt to a storage area. Removal of the droplets from belt 12 is by gravity and/or blade 56.

The lipid product prior to exiting nozzles 32 will be a fluid, and generally will be at a temperature and condition to have a viscosity of about 0.1 Pa·s or below, and more typically of about 0.08 or below, or about 0.05 Pa·s or below, or below 0.01 Pa·s. The introduction of refrigerant into the freezing zone should be sufficient to maintain the pre-cooling zone at a temperature to rapidly cool the lipid product as it enters the pre-cooling area so that lipid droplets have sufficient viscosity so as not to lose their shape while traveling to freezing area 24. Typically, this will cool the lipid product to at least a semisolid state.

As the droplets pass through the pre-cooling area 22 and freezing area 24, the temperature of the droplets is further reduced to bring the lipid at least down to the temperature at which crystallization of the lipid begins, and more typically below the temperature range in which crystallization occurs.

In freezing area 24, the droplets are exposed to refrigerant so as to bring them to the desired solidified state and temperature. Broadly, the freezing area will be in a temperature range from about −40° F. to about 40° F. (about −40° C. to about 4.4° C.). However, the exact temperature will depend on the nature of the lipid product. For example, if the lipid is cocoa butter, the viscosity at 70° C. is about 0.015 Pas and at 35° C. is about 0.05 Pa·s. The onset of crystallization occurs at around 30° C. and typically full solidification occurs around 27° C. If the cocoa butter is continued to be cooled to temperatures in the range of −10° C. to −20° C. range, it exhibits characteristics of a viscosity in the 100 to 150 Pa·s range.

As the lipid enters the sub-cooling area 26 from the freezing area 24, the lipid will typically be warmed somewhat but generally will be maintained below its temperature crystallization range. This temperature is generally maintained for storage and transportation until the frozen lipid product is used.

Generally, pre-cooling area may be from about 5° F. to about 90° F. (about 3° C. to about 50° C.) warmer than freezing area 24, and the sub-cooling area 26 may be from about 5° F. to about 70° F. (about 3° C. to about 22° C.) warmer than freezing area 24. For example, if freezing area 24 is in the range of −10° C. to −20° C., the pre-cooling area may be in the range of from about 10° F. to about 70° F. (about 6° C. to about 39° C.).

More specifically, for example, if freezing area 24 is −20° C. for cocoa butter, the pre-cooling area would be at a temperature sufficient to bring the cocoa butter entering the pre-cooling area to about 35° C. to 20° C. range when it is deposited on belt 12 (which would generally solidify cocoa butter to at least a semisolid), and the sub-cooling area would be at a temperature sufficient to maintain the cocoa butter exiting the freezing zone at a temperature less than 20° C., so that it is in a solid state. Thus, the pre-cooling area could be from 25° C. to −10° C., and the sub-cooling area could be from 20° C. to −15° C.

The lipid product in its frozen droplet state (or frozen particulate state) maintained below the crystallization range remains solid and in a state that does not readily conglomerate, thus being easy to handle and proportion out without the necessity of cutting solid lipid product or dealing with large volumes of liquid lipid product. The resulting solid droplets or particles generally can have a diameter of at least about 1 mm, at least about 2 mm, at least about 5 mm, or at least about 10 mm. Typically, they will be up to about 250 mm, and optionally up to about 200 mm, up to about 150 mm, or up to about 100 mm. The solid characteristics of the frozen lipid product droplets (particles) mean that they can move in a continuous steady stream when poured from a container without clumping together or agglomeration into larger particles. Thus, the droplets remain as individual beads during production, shipping, storage and use—as long as they are kept at the appropriate temperature described herein.

The solid characteristic of the product droplets makes them readily adaptable to machine type packing operations such as might be used on a production line in the packing of large quantities of droplets. The solid characteristic makes the product droplets pourable allowing for the rapid, efficient packing of containers by hand or machine. Additionally, the solid characteristic allows for the use of a wide variety of packaging or container types and shapes, for example cartons (both boxes and pourable cartons such as cardboard milk-carton types), bags, jars and bottles. Also, the solid droplets are suitable for heat sealed plastic and to foils, tubs, tubes and similar packaging.

When lipid product is needed for use at the use site, the solid droplets can be thawed back into a liquid. However, in most cases, thawing is not necessary. In one embodiment, the solid droplets are measured to obtain an appropriate amount for a specific use and blended into the recipe in the frozen solid droplet state.

Various embodiments of the disclosed system and process can be further understood by reference to the following numbered paragraphs.

1. A system for producing solid droplets of lipid product, the system comprising:

a freeze tunnel having a solid flexible conveyor belt configured to pass through a freeze chamber, the freeze tunnel having a plurality of refrigerant nozzles introducing a refrigerant into the freeze chamber; and

a plurality of lipid nozzles to introduce the lipid product onto the conveyor belt at a first end of the freeze tunnel, wherein the lipid product is introduced onto the conveyor belt as a series of droplets and the conveyor belt is configured to carry the droplets from the first end to the second end of the freeze tunnel such that the droplets assume a semisolid state on or before contacting the conveyor belt and are subsequently frozen to a solid state during transit through the freeze tunnel on the conveyor belt.

2. The system according to paragraph 1, further comprising a dye roller which molds the droplets to a predetermined shape during the transit of the droplets through the freeze tunnel.

3. The system according to paragraph 1 or 2, further comprising a blade configured to remove droplets which are stuck to the conveyor belt.

4. The system according to any of paragraphs 1 to 3, further comprising a fan configured to disperse the refrigerant throughout the freeze chamber.

5. The system according to any preceding paragraph, further comprising a lipid chamber configured such that lipid product is fed from the lipid chamber to the plurality of lipid nozzles.

6. The system according to any preceding paragraph, wherein the lipid nozzles are configured to place droplets on the conveyor belt such that the droplets on the conveyor belt are uniform and spaced apart.

7. A process for preparing solid droplets of a lipid product, the process comprising:

introducing the lipid product in a liquid state into a freeze tunnel having a first temperature, wherein the droplets are introduced through at least one nozzle so as to form droplets of the liquid product;

introducing the droplets onto a conveyor belt at a first end of the freeze tunnel, wherein the first temperature is sufficient that the droplets assume a semisolid state on or before contacting the conveyor belt;

moving the conveyor belt through the freeze tunnel such that the conveyor belt carries the droplets from the first end to a second end of the freeze tunnel, and wherein the first temperature is such that the droplets are frozen to a solid state during transit through the freeze tunnel on the conveyor belt;

removing the thus solid droplets from the freeze tunnel at the second end.

8. The process according to paragraph 7, further comprising molding the droplets to a predetermined shape during the transit of the droplets through the freeze tunnel.

9. The process according to either paragraph 7 or paragraph 8, further comprising removing at least a portion of the solid droplets from the conveyor belt by using a blade at the second end.

10. The process according to any of paragraphs 7 to 9, further comprising:

introducing a refrigerant into the freeze tunnel to maintain the first temperature; and

dispersing the refrigerant throughout the freeze chamber.

11. The process according to any of paragraphs 7 to 10, wherein the refrigerant is a liquified gas selected from the group consisting of liquid nitrogen or liquid carbon dioxide.

12. The process according to any of paragraphs 7 to 11, wherein the droplets are introduced onto the conveyor belt such that the droplets on the conveyor belt are uniform and spaced apart.

13. The process according to any of paragraphs 7 to 12, wherein before introduction of the droplets the lipid product has a liquid temperature that is sufficient to achieve a predetermined viscosity for the liquid to pass through the at least one nozzle to form droplets.

14. The process according to any of paragraphs 7 to 13, wherein at the step of removing the solid droplets, the solid droplets are at a second temperature below the crystallization range of the liquid product such that the solid droplets do not conglomerate.

15. The process according to paragraph 14, further comprising collecting the solid droplets in a bin after removing the solid droplets from the freeze tunnel and wherein the collecting of the solid droplets is at the second temperature.

16. The process according to any of paragraphs 7 to 15, wherein the process is carried out on a system according to any of paragraphs 1 to 6.

Therefore, the present systems and methods are well adapted to attain the ends and advantages mentioned, as well as those that are inherent therein. The systems and methods may be modified and practiced in different but equivalent manners apparent to those skilled in the art having the benefit of the teachings herein. Furthermore, no limitations are intended to be the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A system for producing solid droplets of lipid product, the system comprising:
a freeze tunnel having a solid flexible conveyor belt configured to pass through a freeze chamber, the freeze tunnel having a plurality of refrigerant nozzles introducing a refrigerant into the freeze chamber; and
a plurality of lipid nozzles to introduce the lipid product onto the conveyor belt at a first end of the freeze tunnel, wherein the lipid product is introduced onto the conveyor belt as a series of droplets and the conveyor belt is configured to carry the droplets from the first end to the second end of the freeze tunnel such that the droplets assume a semisolid state on or before contacting the conveyor belt and are subsequently frozen to a solid state during transit through the freeze tunnel on the conveyor belt.

2. The system according to claim 1, further comprising a dye roller which molds the droplets to a predetermined shape during the transit of the droplets through the freeze tunnel.

3. The system according to claim 1, further comprising a blade configured to remove droplets which are stuck to the conveyor belt.

4. The system according to claim 1, further comprising a fan configured to disperse the refrigerant throughout the freeze chamber.

5. The system according to claim 1, further comprising a lipid chamber configured such that lipid product is fed from the lipid chamber to the plurality of lipid nozzles.

6. The system according to claim 1, wherein the lipid nozzles are configured to place droplets on the conveyor belt such that the droplets on the conveyor belt are uniform and spaced apart.

7. The system according to claim 6, further comprising:
a dye roller which molds the droplets to a predetermined shape during the transit of the droplets through the freeze tunnel;
a blade configured to remove droplets which are stuck to the conveyor belt;
a fan configured to disperse the refrigerant throughout the freeze chamber; and
a lipid chamber configured such that lipid product is fed from the lipid chamber to the plurality of lipid nozzles.

8. A process for preparing solid droplets of a lipid product, the process comprising:
introducing the lipid product in a liquid state into a freeze tunnel having a first temperature, wherein the droplets are introduced through at least one nozzle so as to form droplets of the liquid product;
introducing the droplets onto a conveyor belt at a first end of the freeze tunnel, wherein the first temperature is sufficient that the droplets assume a semisolid state on or before contacting the conveyor belt;
moving the conveyor belt through the freeze tunnel such that the conveyor belt carries the droplets from the first end to a second end of the freeze tunnel, and wherein the first temperature is such that the droplets are frozen to a solid state during transit through the freeze tunnel on the conveyor belt;
removing the thus solid droplets from the freeze tunnel at the second end.

9. The process according to claim 8, further comprising molding the droplets to a predetermined shape during the transit of the droplets through the freeze tunnel.

10. The process according to claim 8, further comprising removing at least a portion of the solid droplets from the conveyor belt by using a blade at the second end.

11. The process according to claim 8, further comprising:
introducing a refrigerant into the freeze tunnel to maintain the first temperature; and
dispersing the refrigerant throughout the freeze chamber.

12. The process according to claim 11, wherein the refrigerant is a liquified gas selected from the group consisting of liquid nitrogen or liquid carbon dioxide.

13. The process according to claim 8, wherein the droplets are introduced onto the conveyor belt such that the droplets on the conveyor belt are uniform and spaced apart.

14. The process according to claim 8, wherein before introduction of the droplets the lipid product has a liquid temperature that is sufficient to achieve a predetermined viscosity for the liquid to pass through the at least one nozzle to form droplets.

15. The process according to claim 14, wherein at the step of removing the solid droplets, the solid droplets are at a second temperature below the crystallization range of the liquid product such that the solid droplets do not conglomerate.

16. The process according to claim 15, further comprising collecting the solid droplets in a bin after removing the solid droplets from the freeze tunnel and wherein the collecting of the solid droplets is at the second temperature.

17. The process according to claim 16, further comprising removing at least a portion of the solid droplets from the conveyor belt and into the bin by using a blade at the second end.

18. The process according to claim 17, further comprising:
introducing a refrigerant into the freeze tunnel to maintain the first temperature; and
dispersing the refrigerant throughout the freeze chamber; and
molding the droplets to a predetermined shape during the transit of the droplets through the freeze tunnel.

19. The process according to claim 18, wherein the refrigerant is a liquified gas selected from the group consisting of liquid nitrogen or liquid carbon dioxide.

20. The process according to claim 19, wherein the droplets are introduced onto the conveyor belt such that the droplets on the conveyor belt are uniform and spaced apart.
